(19) United States
(12) Patent Application Publication
(10) Pub. No.: US 2003/0125971 A1
(43) Pub. Date: Jul. 3, 2003

(54) Non-custodial and/or custodial parent location service

(75) Inventors: Vijay J. Tambay, Miami, FL (US); Cindy Hielscher, Nashville, TN (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Accenture Global Services GmbH

(21) Appl. No.: 10/216,665

(22) Filed: Aug. 12, 2002

Related U.S. Application Data
(60) Provisional application No. 60/311,123, filed on Aug. 10, 2001.

(51) Int. Cl. G06F 17/60

(52) U.S. Cl. 705/1

(57) ABSTRACT

Systems and methods for locating non-custodial and/or custodial parents are disclosed. The systems and methods involve, in some illustrative embodiments: providing at least one regional child support enforcement computer system having at least one data storage device containing required data collected from required locate sources; providing a locate engine computer system having at least one data storage device containing supplementary data; transmitting said required data via a public network to a locate engine computer system and storing said required data along with said supplementary data; preliminarily locating a subject non-custodial parent or custodial parent by matching said required and supplementary data via said locate engine to obtain location data; transmitting the location data related to the preliminarily located non-custodial parent or a custodial parent to a location unit computer system; transmitting from the location unit computer system location data having a verified address and/or telephone number for the subject to at least one of a regional child support enforcement computer system, an establishment computer system, and an enforcement computer system.

The present application claims priority to U.S. Provisional Patent Application No. 60/311,123, filed on Aug. 10, 2001, entitled Non-Custodial And/Or Custodial Parent Location Service, the entire disclosure of which is incorporated herein by reference as though recited herein in full.

### Field of the Invention

The present invention relates generally to services for locating non-custodial and/or custodial parents.

### Description of the Background

In the United States, a Child Support Enforcement (CSE) Program has been established that requires States and territories to locate non-custodial parents (NCPs). Specifically, in 1975, Congress created the CSE Program by enacting title IV-D of the Social Security Act for the purpose of establishing and enforcing the support obligations owed by non-custodial parents to their children. The CSE Program is a joint undertaking involving Federal, State, and local cooperative efforts. Because the States and territories run their own CSE programs, there are about 54 separate systems, each with it's own unique laws and procedures.

The Department of Health and Human Services (DHHS) is the Federal agency that oversees administration of the CSE Program. Within DHHS, the Administration for Children and Families' Office of Child Support Enforcement (OCSE) provides Federal oversight of the Program. OCSE sets program standards and policy, evaluates States' performance in conducting their programs, and offers technical assistance and training to States.

State governments work directly with families through State child support enforcement agencies and/or their local counterparts. These agencies work closely with a variety of government entities in four areas: locating non-custodial parents; establishing paternity; establishing support orders; and collecting and distributing support.

CSE services are available to families receiving assistance under the new Temporary Assistance for Needy Families (TANF) Program and to families not receiving TANF who apply for such services. Child support payments that are collected on behalf of the family (e.g., operating as an agent for the family) are sent to the family.

State child support offices work with prosecuting attorneys and other law enforcement agencies to establish and enforce support orders. Each State CSE agency operates under a State plan approved by OCSE. State governments, and in some cases city, county, and/or local governments, participate in funding the program.

In the location process, the federal government mandates some sources that must be used to locate NCPs—e.g., New Hires Registry, Federal Case Registry, etc. In the location process, the CSE program finds the following information for each NCP: name; social security number (SSN); date of birth (DOB); mailing address/residential address; employer address; and assets (financial assets, moveable assets, and fixed assets).

FIG. 1 schematically illustrates aspects of the current location process. As shown, an individual CSE Program entity 10 (e.g., one of the 54 States or territories) acquires data from the limited prescribed sources, such as the Federal Case Registry (FCR); the State Case Registry (SCR), Directories of New Hires (NH), the Department of Motor Vehicles (DMV), Professional Licenses Directories (PL), etc. The existing methods are limited and include that: 1) a new case is initiated (e.g., an application for CSE Program services is submitted and accepted); 2) if the NCP is not located, a limited location procedure is initiated; 3) the location procedure involves a substantially exact matching of data by the entity 10 (if no match is found, no result is achieved); 4) if a match is found, establishment handling persons or entities 30 or enforcement handling persons or entities 50 are notified (e.g., in some states with minimal automation but usually through manual communications i.e., daily or weekly reports).

The ability to locate NCPs directly impacts the establishment of paternity, the establishment of orders for the payment of child support, and the enforcement of support orders. It, therefore, has a substantial and direct impact on the total collections of a state and consequently on 4 of the 5 federal performance benchmarks. Currently, all CSE programs perform locating functions “in-house,” using limited systems that just meet the mandated federal requirements. Existing systems have significant problems including, that locating individuals has been time consuming, inaccurate and costly due to:

the need for multiple applications and data sources;

the need to employ significant numbers of persons to conduct manual searching and location efforts (e.g., often costing about $3 to $6 million per year in one given region, e.g., state, alone);

the need for multiple unproductive searches per subject;

the presence of unsatisfactory match rates; and

the use of slow performing services.

In addition to the non-custodial parent location problems, CSE programs are faced with difficulties in locating custodial parents. Though it is to a custodial parents benefit that they inform the CSE programs as to their whereabouts—they frequently do not inform the CSE program when they move to a new address. As a result, CSE programs have been wrestling with millions of dollars in undistributed and undisbursed funds that they are unable to distribute. A significant amount of the backlog in undistributed and undisbursed funds is attributable to the existing difficulties in locating custodial parents.

There is a significant need for improved systems and methods for locating non-custodial parents and/or custodial parents.

### SUMMARY OF THE PREFERRED EMBODIMENTS

The preferred embodiments of the invention overcome various problems and limitations in the existing non-custodial parent location service processes.

In illustrative, non-limiting, preferred embodiments of the invention, a method for locating non-custodial and/or custodial parents is provided that comprises:

providing at least one regional child support enforcement computer system having at least one database containing required data collected from required locate sources;

providing a locate engine computer system having at least one database containing supplementary data (preferably, the supplementary data includes, but is not limited to, data collected from one or more of the following sources: telephone companies; utility companies [e.g., electric companies, gas companies, water companies, etc.]; and credit bureaus);

transmitting said required data via a public network, such as the Internet, to a locate engine computer system and storing said required data along with said supplementary data (preferably, the transmission is encrypted or otherwise secured);

preliminarily locating a subject non-custodial parent or custodial parent by matching said required and supplementary data via said locate engine (preferably, the matching utilizes fuzzy logic algorithms) to obtain location data;

providing a location unit including at least one physical building location including office space for employees, telephone equipment or other oral communications systems, and a location unit computer system;

transmitting the location data related to the preliminarily located non-custodial parent or a custodial parent to the location unit computer system;

transmitting from the location unit computer system location data having a verified address and/or telephone number for the subject to at least one regional child support enforcement computer system (or to an establishment computer system, enforcement computer system, and/or to another regional CSE computer system);

processing location data having information related to the subject's affiliates (e.g., relatives or the like) by location unit skip tracing conducted by location unit employees.

Preferably, the location unit and the location engine are independently owned, controlled and/or managed from the ownership, control and/or management of the CSE computer system (e.g., under a regional government). In addition, the location unit and the locate engine computer system preferably provide such services for a plurality of independent CSE Programs having respective computer systems in various regions across the United States and/or in other countries and/or regions worldwide. Preferably, the various entities (e.g., governmental entities) that own, control and/or manage the respective regional CSE Programs are charged a service fee for the use of the location unit, location engine and/or other services. The service fee is preferably charged on a subscription basis, and, preferably, for subscriptions of greater than about a one year term, and preferably, for subscriptions of at least a multiple year term.

The above and other aspects, features and/or advantages of preferred embodiments of the invention will be further appreciated in view of the following description and the accompanying drawings. It is contemplated that various embodiments will include and/or exclude different aspects, advantages and/or benefits and that descriptions of aspects, advantages and/or benefits of the various embodiments should not be construed as limiting other embodiments nor the inventions claimed.

### BRIEF DESCRIPTION OF THE DRAWINGS

The preferred embodiments of the present invention are shown by way of example, and not limitation, in the accompanying drawings, in which:

FIG. 1 is a schematic diagram showing aspects of current location processes;

FIG. 2A is a schematic diagram of a preferred embodiment of a location process according to the present invention;

FIG. 2B is a schematic diagram showing illustrative architectural structure for implementing preferred embodiments of the present invention;

FIG. 2C is a schematic diagram showing other illustrative architectural structure for implementing preferred embodiments of the present invention; and

FIGS. 3A and 3B are business process descriptions that together show process steps according to preferred embodiments of the invention.

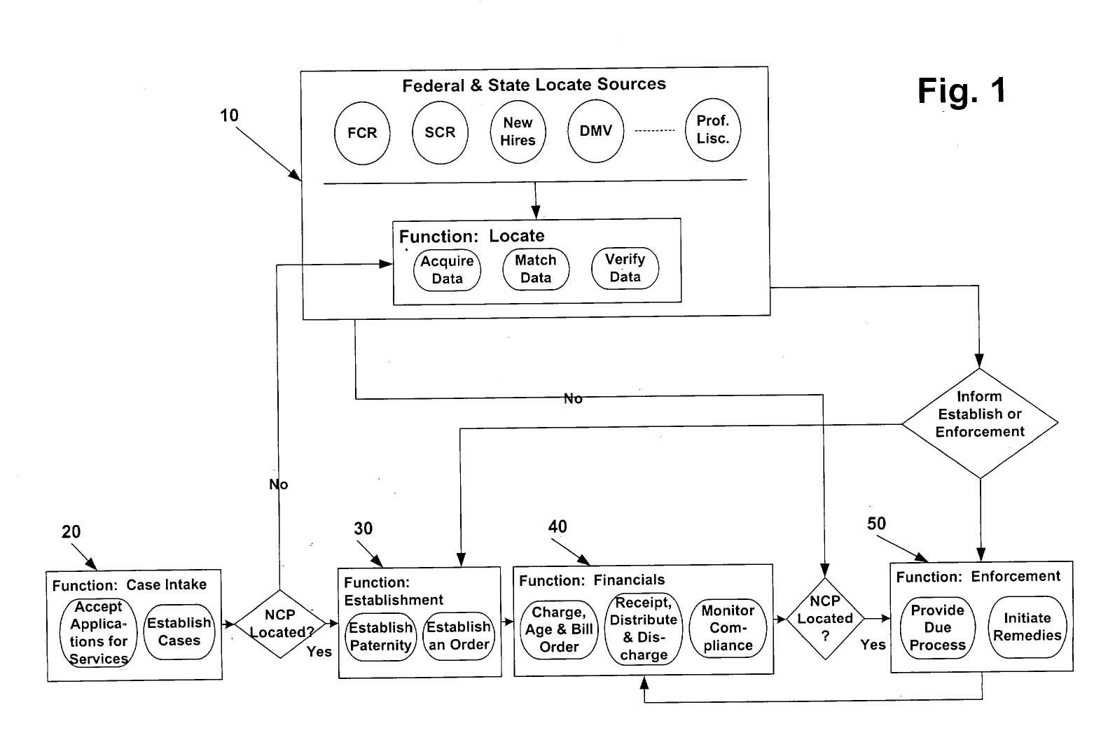

### DETAILED DESCRIPTION OF THE PREFERRED EMBODIMENTS

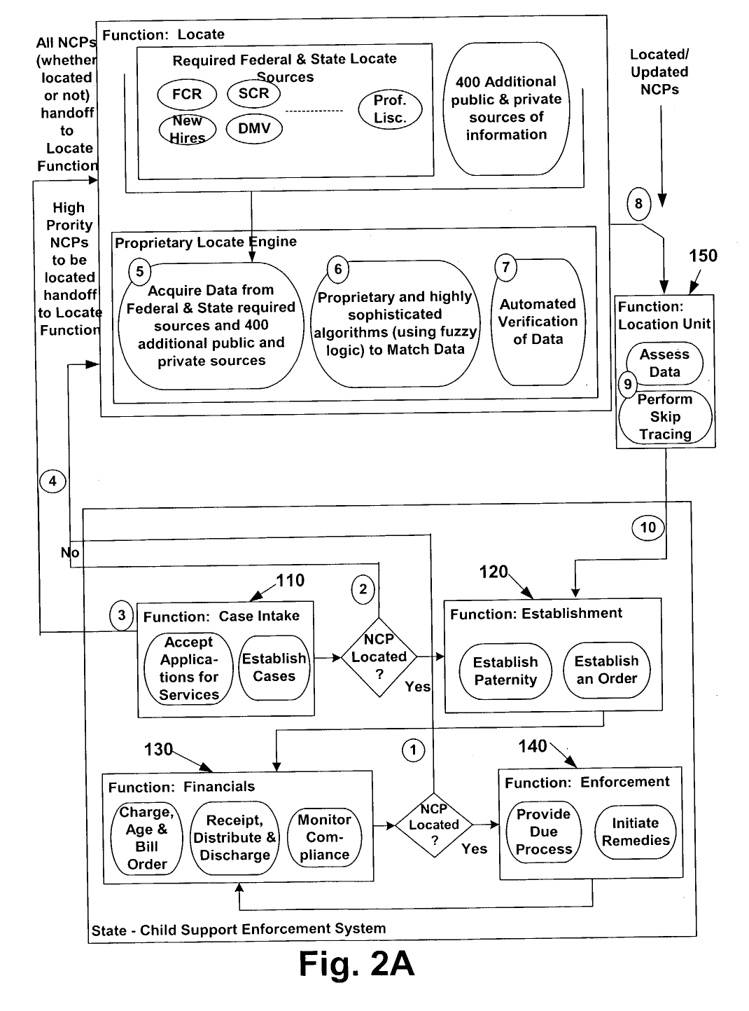

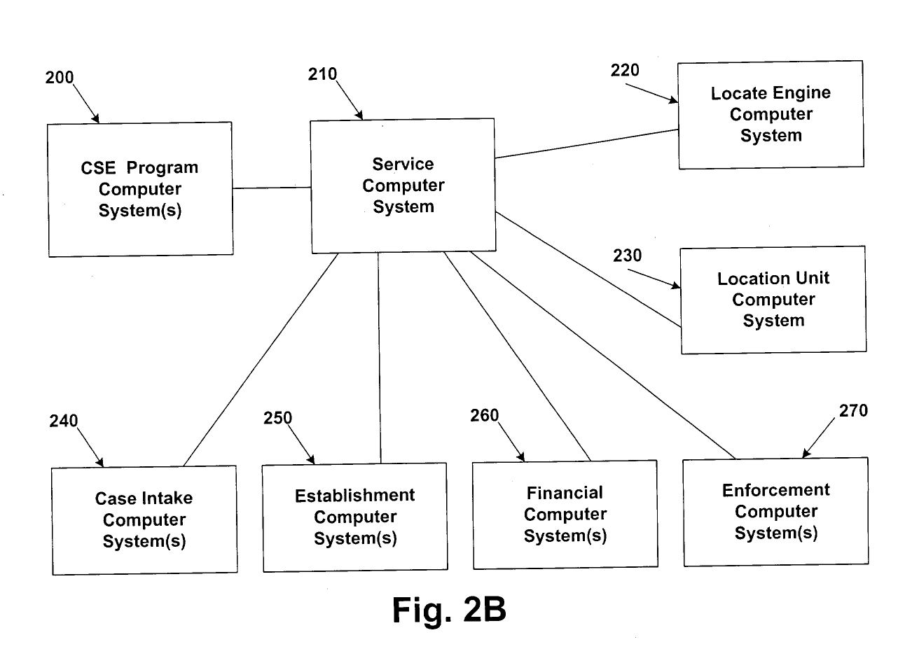

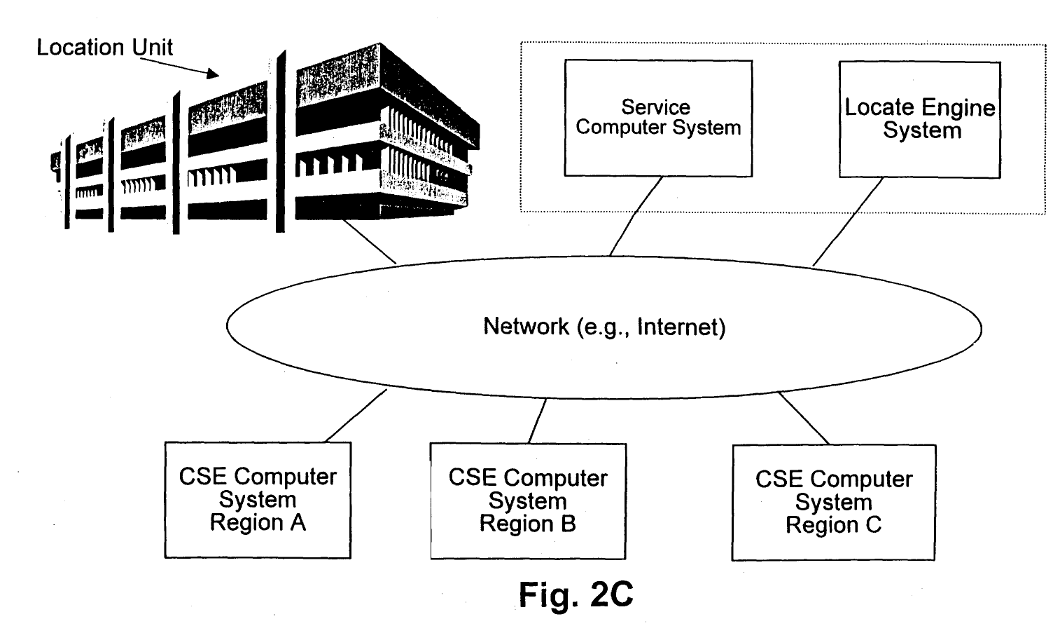

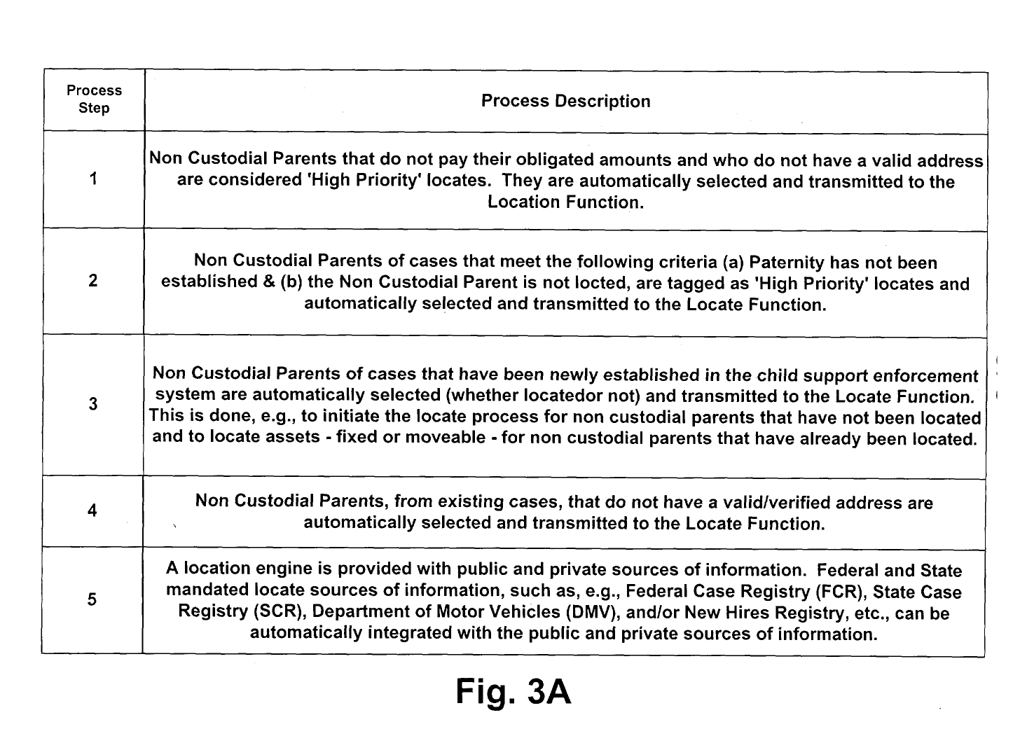

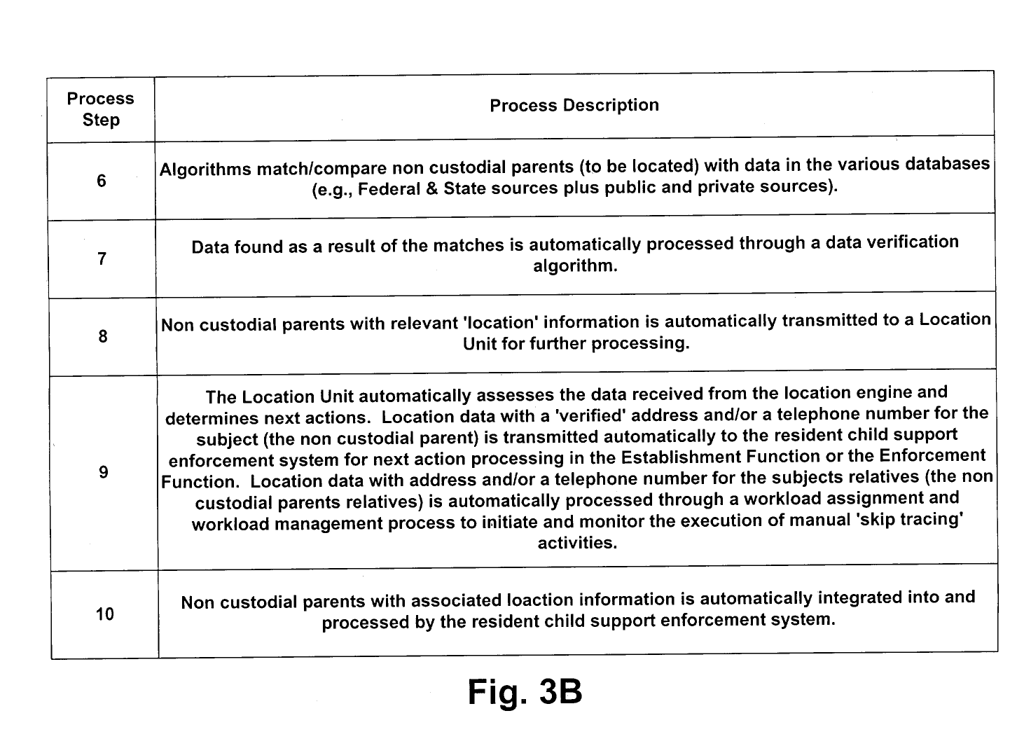

Preferred embodiments of a location service system and method according to the present invention are shown schematically in FIG. 2A and preferred procedural steps related thereto are shown in FIGS. 3A and 3B.

FIGS. 2B and 2C show illustrative architectural structures for implementing the preferred embodiments of the present invention. In the illustrative and non-limiting embodiment shown in FIG. 2B, the various computer systems preferably communicate using appropriate protocols via appropriate wireless, optical, electrical or other communications mediums (e.g., using a network or a system of networks, including, for example, the Internet (e.g., using protocols, such as HTTP, TCP/IP and the like), a wide area network (WAN), a local area network (LAN), a virtual private network (VPN) and/or other networks). Preferably, communications are encrypted and/or otherwise secured. In some illustrative and non-limiting cases, computers and computer systems (e.g., containing one or more computers) employed can include, e.g.: central processing units, memory (e.g., RAM, etc.), digital data storage (e.g., hard drives, etc.), input/output ports (e.g., parallel and/or serial ports, etc.), data entry devices (e.g., key boards, etc.), etc.

While separate computer systems are pictured in FIG. 2B, one or more of the computer systems can be combined into a single computer system or computer in other embodiments. For example, in some embodiments, at least two of the case intake computer system 240, the establishment computer system 250, the financial computer system 260, the enforcement computer system and/or the CSE program computer system 200 can be combined into a single computer or computer system. As another example, at least two of the service computer system 210, the locate engine computer system 220 and the location unit computer system 230 can be combined into a single computer or computer system.

In the illustrative embodiment shown in FIG. 2C, a plurality of illustrative regional CSE computer systems are shown—namely, CSE Computer System for Region A, CSE Computer System for Region B and CSE Computer System for Region C (any number of regional computer systems can employ these location services). In FIG. 2C, the CSE Computer Systems preferably include the functionality of systems 200, 240, 250, 260 and/or 270 shown in FIG. 2B. As shown in dashed lines in FIG. 2C, the service computer system and the locate engine system can be combined into a single computer or computer system in some alternative embodiments.

As also shown in FIG. 2C, the Location Unit preferably includes at least one physical office building location including facilities for at least about 20 to 200 employees, along with office space, telephones and/or other oral communications means, a location unit computer system, and other office equipment. The Location Unit, its equipment, facilities and employees are preferably owned, controlled and/or managed by a different entity than that owning, controlling and/or managing the regional CSE Enforcement Programs. In the embodiment shown in FIG. 2C, the various computer systems preferably communicate using appropriate protocols (e.g., TCP/IP or other protocols) via appropriate wireless, optical electrical or other communications mediums (e.g., using any network, but most preferably using the Internet). Preferably, transmissions are encrypted and/or otherwise secured. In one illustrative and non-limiting embodiment, data transmissions are conducted via HTTPS using a 128 bit encryption SSL.

In an illustrative embodiment of the present invention, a non-custodial parent and/or custodial parent location service method can include some or all of the following steps.

In step 1 (shown in FIGS. 3A and 2A), a determination is preferably made of the non-custodial parents who do not pay their obligated amounts and who do not have a valid address. These individuals are identified as “high priority” and are automatically selected and submitted to a location function component 100. In some preferred embodiments, data pertaining to these high priority individuals is submitted to the location function component in real time promptly upon identification thereof and/or on a periodic basis (e.g., once a day or the like). In the illustrative example shown in FIG. 2B, the automatic selection of these individuals can be performed at a financial computer system 260 that communicates with the service computer system 210 that, in turn, communicates with and controls processing via the locate engine computer system 220. Similarly, in the illustrative example shown in FIG. 2C, the automatic selection of these individuals can be performed at a respective regional CSE Computer System.

In step 2 (shown in FIG. 3A and FIG. 2A), a determination is preferably made of the instances in which a) paternity has not been established and b) the non-custodial parent is not located. These individuals are identified as “high priority,” are automatically selected and are submitted to the location function component 100. In some preferred embodiments, data pertaining to these high priority individuals is submitted to the location function component in real time promptly upon identification thereof and/or on a periodic basis (e.g., once a day or the like). In the illustrative example shown in FIG. 2B, the automatic selection of these individuals can be performed, for example, at the case intake computer system 240 that communicates with the service computer system 210 that, in turn, communicates with and controls processing via the locate engine computer system 220. Similarly, in the illustrative example shown in FIG. 2C, the automatic selection of these individuals can be performed at a respective regional CSE Computer System.

In step 3 (shown in FIGS. 3A and 2A), all of the non-custodial parents in cases that have been newly established and entered into the CSE system are automatically selected (e.g., via the case intake computer system 240 in FIG. 2B, a regional CSE Computer System in FIG. 2C, or the like) and transmitted to the locate function component 100 (e.g., via the service computer system 210 or the like). In some preferred embodiments, data pertaining to these individuals is submitted to the location function component in real time promptly upon identification thereof and/or on a periodic basis (e.g., once a day or the like).

In step 4 (shown in FIGS. 3A and 2A), non-custodial parents, from existing cases, that do not have a valid and/or verified address are automatically selected (e.g., via the case intake computer system 240, a regional CSE Computer System in FIG. 2C, or the like) and transmitted to the locate function component 100 (e.g., via the service computer system 210 or the like). In some preferred embodiments, data pertaining to these individuals is submitted to the location function component in real time promptly upon identification thereof and/or on a periodic basis (e.g., once a day or the like).

In step 5 (shown in FIGS. 3A and 2A), federal and state mandated locate sources of information (e.g., Federal Case Registry information, State Case Registry information, Department of Motor Vehicles information, New Hires Registry information, etc.) are integrated with other public and private sources of information (e.g., acquired independently from the CSE Program from various other sources, including, for example, from telephone companies, utility companies, and/or credit bureaus, etc.) into a database or set of databases of the locate engine. In one illustrative and non-limiting embodiment, this mandated information can be transmitted from CSE Program computer system(s) 200 to the service computer system 210, and then transmitted and integrated into the databases utilized by the locate engine computer system 220. In some preferred embodiments, the CSE Program computer systems 200 (e.g., regional computer systems) include mainframe computers having databases containing such mandated information, such mandated information having been loaded into said mainframe computers from various sources, including local sources and federal sources. Preferably, software is installed in the mainframe computers to upload this information to the service computer system 210. Preferably, the information is uploaded on a periodic basis—such as, as just one example, on a daily basis.

In step 6 (shown in FIGS. 3B and 2A), the locate engine matches and compares non-custodial parents to be located with data in one or more databases using fuzzy logic and/or other algorithms to match data. In step 7 (shown in FIGS. 3B and 2A), the locate engine automatically processes data found as a result of matches through a data verification algorithm. In one illustrative and non-limiting embodiment, the locate engine can include engine computer system 220 shown in FIG. 2B or 2C. As discussed above, in some embodiments, the locate engine could also be combined with the service computer system.

In one illustrative embodiment, the locate engine can include a system such as that of SEISINT, INC., which facilitates the use of data supplies via massive parallel technologies that enable access, analysis, manipulation and storage of extensive amounts of data, across disparate databases, in fractions of a second. Preferably, the system uses a large number of parallel processors, and preferably about 100 or more, or even about 1000 or more parallel processors. The system preferably works with substantially any computing platform, via the Internet or private networks, and on distributed or centralized computer systems. The system also preferably merges and sorts information in different databases into a single view. Preferably, the system operates using fuzzy logic to identify matches and is configured such that it, among other things, obtains matches from various partial pieces of information and/or takes partial information to come up with further information and re-evaluates based on the original information and the further information discovered to identify further matches.

In step 8 (shown in FIGS. 3B and 2A), the non-custodial parents with relevant location information data is automatically transmitted to a Location Unit for further processing. In the illustrative and non-limiting embodiments shown in FIGS. 2B and 2C, the Location Unit can include a location unit computer system 230 that receives the relevant information data and processes the same.

In step 9 (shown in FIGS. 3B and 2A), the Location Unit automatically assesses the data received from the location engine and determines the next action steps to be taken. For example, location data with a “potentially verified” address and/or a “potentially verified” telephone number for the non-custodial parent can be transmitted automatically to the resident child support enforcement system for final state specific verification procedures and following action processing under the establishment function and/or the enforcement function. On the other hand, location data with address and/or telephone numbers for the non-custodial parent's relatives can be automatically processed through a workload assignment and workload management process (e.g., preferably, computer generated and arranged) to initiate and monitor the execution of manual “skip tracing” activities. “Skip tracing” activities can include, for example, known skip tracing procedures such as telephone contact and the like procedures handled manually by service persons located and employed within the at least one Location Unit physical building structure.

In step 10 (shown in FIGS. 3B and 2A), the information related to the non-custodial parents with associated location information is automatically forwarded for processing by the respective regional (i.e., state or territory) CSE Program system. As shown schematically in the illustrative and non-limiting example of FIG. 2B, the local CSE Program system preferably includes a one or more computer 200 for automatically receiving said information and, preferably, for automatically processing the same.

### BROAD SCOPE OF THE INVENTION

While illustrative embodiments of the invention have been described herein, it will be appreciated that the present invention is not limited to the various embodiments described herein, but includes any and all embodiments having modifications, omissions, combinations (e.g., of aspects across various embodiments), adaptations and/or alterations as would be appreciated by those in the art based on the present disclosure. The appended claims are to be interpreted broadly based the language employed in the claims and not improperly limited to illustrative examples described in the present specification or in the prosecution of the application. As merely one example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts are not recited in support of that function.

What is claimed is:

1. A method for locating non-custodial and/or custodial parents, comprising:
providing at least one regional child support enforcement computer system having at least one data storage device containing required data collected from required locate sources;
providing a locate engine computer system having at least one data storage device containing supplementary data;
transmitting said required data via a public network to a locate engine computer system and storing said required data along with said supplementary data;
preliminarily locating a subject non-custodial parent or custodial parent by matching said required and supplementary data via said locate engine to obtain location data;
transmitting the location data related to the preliminarily located non-custodial parent or a custodial parent to a location unit computer system;
transmitting from the location unit computer system location data having a verified address and/or telephone number for the subject to said at least regional child support enforcement computer system.

2. The method of claim 1, further including processing location data having information related to a subject's affiliates by skip tracing conducted by location unit employees.

3. The method of claim 1, further including providing a location unit including at least one physical building location including office space for employees, oral communications systems, and a location unit computer system.

4. The method of claim 3, further including having the location unit and the location engine independently owned, controlled and managed from the ownership, control and management of said at least one regional child support enforcement computer system.

5. The method of claim 1, wherein said at least one regional child support enforcement computer system includes a plurality of systems associated with independent child support enforcement programs in a plurality of geographic regions.

6. The method of claim 5, wherein entities that own, control and/or manage the respective regional child support enforcement programs are charged a service fee for use of the location unit and/or the location engine.

7. The method of claim 6, wherein the service fee is charged on a subscription basis.

8. The method of claim 7, wherein the subscription basis is for a term of greater than about a one year.

9. The method of claim 1, further including performing a determination of non-custodial parents who do not pay their obligated amounts and who do not have a valid address, and automatically submitting data regarding such non-custodial parents to the locate engine computer system.

10. The method of claim 9, wherein an automatic selection of the individuals automatically submitted to the locate engine computer system is performed by a financial computer system.

11. The method of claim 1, further including determining instances in which either a) paternity has not been established or b) the non-custodial parent is not located, and automatically submitting such data regarding such non-custodial parents to the locate engine computer system.

12. The method of claim 11, wherein an automatic selection of the individuals submitted to the locate engine computer system is performed by a case intake computer system.

13. The method of claim 1, further including automatically selecting substantially all non-custodial parents in cases that have been substantially newly established, and automatically submitting data regarding such non-custodial parents to the locate engine computer system.

14. The method of claim 13, wherein an automatic selection of the individuals submitted to the locate engine computer system is performed by a case intake computer system.

15. The method of claim 1, further including performing a determination of non-custodial parents, from existing cases, who do not have a valid and/or verified address, and automatically submitting data regarding such non-custodial parents to the locate engine computer system.

16. A method for locating non-custodial and/or custodial parents using at least one computer system, comprising:
providing a plurality of regional child support enforcement computer systems;
providing a locate engine computer system in communication with said plurality of child enforcement computer systems;
locating a subject non-custodial parent or custodial parent using said locate engine computer system;
transmitting location data related to the located subject non-custodial or custodial parent to at least one of said child support enforcement computer systems.

17. The method of claim 16, wherein said regional child support enforcement computer systems each includes at least one of a case intake computer system, an establishment computer system, a financial computer system, and an enforcement computer system.

18. A computer system for locating non-custodial and/or custodial parents, comprising:
a plurality of regional child support enforcement computer systems;
a locate engine computer system in communication with said plurality of child enforcement computer systems, including means for locating a subject non-custodial parent or custodial parent using said locate engine computer system and including means for transmitting location data related to the located subject non-custodial or custodial parent to at least one of said child support enforcement computer systems.
